(19) United States
(12) Patent Application Publication
(10) Pub. No.: US 2005/0058972 A1
(43) Pub. Date: Mar. 17, 2005

(54) Method for censorship

(76) Inventor: Michael E. McDole, Bonita Springs, FL (US)

Correspondence Address: Edward M. Livingston, P.A., 963 Trail Terrace Drive, Naples, FL, 34103, US

(21) Appl. No.: 10/649,080

(22) Filed: Aug. 27, 2003

(51) Int. Cl. G09B 19/00

(52) U.S. Cl. 434/156

(57) ABSTRACT

A method for censorship comprising the steps of a) identifying the objectionable material (2) and b) using an unoffensive symbol (3) to substitute the objectionable material (2). A common method used to censor objectionable material (2) within a body of work (1) is by simply prohibiting the viewing of the work in its entirety. Arguably, however, as in the case of classic literature being banned from schools due to objectionable words, the consequences resulting from the prohibition of reading such books far exceeds the rewards. Thus, the present invention helps to provide unoffensive reading and/or viewing of objectionable works. The reader/viewer will be able to read or view the entire body of work (1) with the objectionable material (2) replaced with an unoffensive symbol (3), preferably a box. Thus, the reader will gain the benefits from reading and/or viewing the body of work (1) without the adverse consequences of censorship.

### BACKGROUND OF THE INVENTION

This invention relates to a method of censoring materials that are deemed inappropriate.

Whether a body of work is moral or immoral is a question in which courts, school systems, journalists, and others have consistently struggled with throughout history. The test for morality is completely subjective: what is deemed moral to one may offend another. In addition, societal standards continuously change over time, essentially leaving certain members of the public confused when something once acceptable, such as the use of the word “nigger,” has now become unacceptable. Although indecency standards change over time, there is still one classically preferred method of prohibiting the public from viewing obscene material: censorship.

Censorship has a deep-seeded history dating back to 443 B.C. when magistrates, also known as censors, acted as census takers, assessors, and inspectors of morals and conduct. Today, a common method of censorship of objectionable materials, be it writings or drawings, is to completely withhold it from the people. This is especially true when dealing with schools.

More recently than ever, censoring books at schools is becoming commonplace. Classical works such as The Catcher in the Rye, The Adventures of Huckleberry Finn, and Of Mice and Men have notoriously been challenged by school systems as being too sexually explicit or containing offensive language. Other works, such as The Chocolate War, A Day No Pigs Would Die, and To Kill a Mockingbird, have also been banned from schools for similar reasons. It is arguable that by preventing today's students from reading such classics as those listed above, schools are doing more harm than good. Thus, the need for a method of censorship exists which would provide people the opportunity to view bodies of work containing objectionable material without actually viewing the objectionable material.

Thus, the present invention helps to eliminate the need of prohibiting works from schools based upon objectionable language or graphics by from substituting the objectionable material with an unoffensive symbol, preferably a box. By using the present invention, students may read or view the body of work without reading or viewing the objectionable material.

The prior art includes the following United States patents:

| Patent No. | Inventor | Filing Date | Issue Date |
|---|---|---|---|
| 3,942,621 | Karlan | Apr. 28, 1970 | Mar. 09, 1976 |
| 5,366,377 | Miller | Jul. 30, 1993 | Nov. 22, 1994 |
| 2,142,761 | Quinn | Apr. 26, 1938 | Jan. 03, 1939 |
| 5,832,212 | Cragun et al. | Apr. 19, 1996 | Nov. 03, 1998 |
| 6,065,056 | Bradshaw et al. | Aug. 13, 1998 | May 16, 2000 |
| 4,734,036 | Kasha | Nov. 26, 1985 | Mar. 29, 1988 |
| 6,199,081 | Meyerzon et al. | Jun. 30, 1998 | Mar. 06, 2001 |

and an eBay publication dated Jul. 3, 2003 by iwish200.

### SUMMARY OF THE INVENTION

The primary object of the present invention is to provide a method for censorship where only the objectionable word or graphic is substituted with an unoffensive symbol so as to permit the reader or watcher to still grasp the main idea of the censored material.

Another object of the present invention is to promote the reading of selected books that have been banned by schools due to objectionable language by essentially substituting the objectionable language with an unoffensive symbol.

A further object of the present invention is to promote unoffensive viewing of websites on the Internet.

The present invention fulfills the above and other objects by providing a method for censorship where an unoffensive symbol, preferably a box, is replaces the objectionable material.

The above and other objects, features, and advantages of the present invention should become even more readily apparent to those skilled in the art upon a reading of the following detailed description in conjunction with the drawings wherein there is shown and described illustrative embodiments of the invention.

### BRIEF DESCRIPTION OF DRAWINGS

This invention is described by appended claims in relation to a description of a preferred embodiment with reference to the following drawings which are explained briefly as follows:

FIG. 1 is an excerpt from The Adventures of Huckleberry Finn without the use of the present invention; and

FIG. 2 is an embodiment of FIG. 1 with the use of the present invention.

### DESCRIPTION OF PREFERRED EMBODIMENT

Listed numerically below with reference to the drawings are terms used to describe features of this invention. These terms and numbers assigned to them designate the same features throughout this description.
1. body of work 3. unoffensive symbol
2. objectionable material

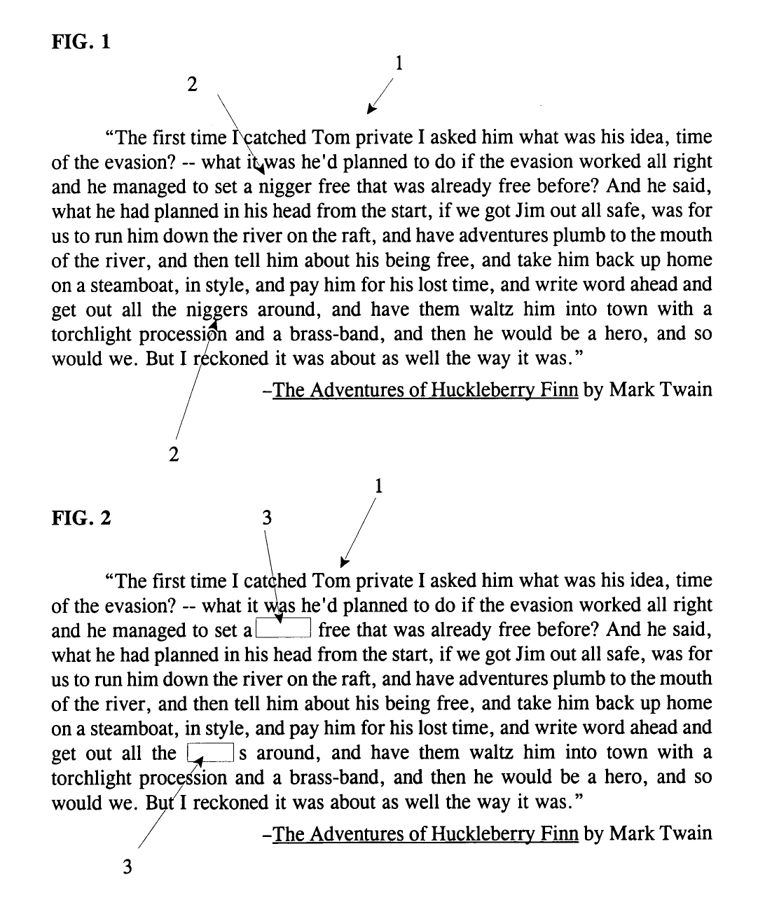

With reference to FIG. 1, an excerpt from The Adventures of Huckleberry Finn without the use of the present invention is shown. The body of work 1 is the entire literature itself. The objectionable material 2 is located within the body of work 1.

With reference to FIG. 2, the same body of work 1 as in FIG. 1 is shown with the use of the present invention. The unoffensive symbol 3 replaces the objectionable material 2, thereby permitting a student to read the literature classic without being exposed to the objectionable material 2.

The use of the present invention will allow schools and others to safely censor objectionable materials without eliminating the availability of the entire work. Although the objectionable material will not be viewed, a person will still be able to grasp the concept of the replaced word from cues of the surrounding context of the work.

Further, the method of this invention can be used for any textual work, such as a slogan on a T-shirt, wherein an offensive word could be replaced with a unoffensive symbol, such as a box, thus leaving it up to the subjective imagination of a viewer as for the missing word.

Even furthermore, such a method of censorship can be used to replace offensive symbols in Braille so blind persons can also read works containing censored matters.

It is to be understood that while a certain form of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

1. A method for censoring comprising the steps of:
a. identifying the material to be banned; and
b. using an unoffensive symbol in place of said material to be banned.

2. The method claimed in claim 1 wherein:
said material to be banned is textual matter.

3. The method claimed in claim 1 wherein:
said material to be banned are images.

4. The hand restraint of claim 1 wherein:
said material to be banned is transmitted over a visual arts medium.

5. The method claim of claim 1 wherein:
said unoffensive symbol is a box; and
said box is sized so as to replace the entire area of the material to be banned.
